(19) United States
(12) Patent Application Publication
(10) Pub. No.: US 2025/0279509 A1
(43) Pub. Date: Sep. 4, 2025

(54) MANUFACTURING METHOD FOR ELECTRICAL ENERGY STORAGE DEVICE

(71) Applicant: Prime Planet Energy & Solutions, Inc., Tokyo (JP)

(72) Inventor: Taisuke ISEDA, Kobe-shi (JP)

(21) Appl. No.: 19/061,928

(22) Filed: Feb. 24, 2025

(30) Foreign Application Priority Data
Mar. 1, 2024 (JP) 2024-031736

(51) Int. Cl. H01M 50/103; B21D 5/16; B23K 26/20; H01G 11/84; H01M 10/0525; H01M 10/0585; H01M 10/0587; H01M 50/119

(52) U.S. Cl. CPC H01M 50/103; B21D 5/16; B23K 26/20; H01G 11/84; H01M 10/0525; H01M 10/0585; H01M 10/0587; H01M 50/119

(57) ABSTRACT

A manufacturing method for an electrical energy storage device disclosed herein includes: a preparing step of preparing a plate material that is made of metal and includes a first part forming a first surface of a case, and a pair of second parts extending from the first part and forming a pair of second surfaces of the case; and a wrapping step of disposing an electrode body on the first part of the plate material and bending the plate material so that a distance between the pair of second parts decreases, thereby wrapping the electrode body.

### CROSS REFERENCE TO RELATED APPLICATION

This application claims the benefit of priority to Japanese Patent Application No. 2024-031736 filed on Mar. 1, 2024. The entire contents of this application are hereby incorporated herein by reference.

### BACKGROUND OF THE DISCLOSURE

### 1. Field

The present disclosure relates to a manufacturing method for an electrical energy storage device.

### 2. Background

In general, an electrical energy storage device includes an electrode body and a case that accommodates the electrode body. One of the references of the conventional art related to a manufacturing method for an electrical energy storage device is Japanese Patent No. 4537353. Japanese Patent No. 4537353 describes to manufacture a square battery by preparing a case main body whose cross sectional shape is like a letter U with one surface open, inserting an electrode body into the case main body through the opening, and then closing the opening with a sealing plate.

### SUMMARY

According to the present inventor's knowledge, the electrode body is often formed to be as large as possible within the range of being able to be inserted through the opening of the case main body from the viewpoints of improving the volume energy density, and the like. Therefore, in some cases, when the electrode body is inserted through the opening, an outer peripheral part of the electrode body is caught at the opening and the accommodation has been difficult. In addition, at the insertion, the electrode body may be in contact with the opening, which results in a crease in a separator of the electrode body or displacement of an electrode plate.

The present disclosure has been made in view of the above circumstances, and an object is to provide a novel manufacturing method for an electrical energy storage device in which an accommodation property of an electrode body is improved.

The present disclosure provides a manufacturing method for an electrical energy storage device including one or a plurality of electrode bodies and a case that has a square shape and accommodates the electrode body or the electrode bodies, in which the case includes at least a first surface, a pair of second surfaces extending from a pair of edges of the first surface and facing each other, and a third surface facing the first surface. This manufacturing method includes: a preparing step of preparing a plate material that is made of metal and includes at least a first part forming the first surface of the case, and a pair of second parts extending from the first part and forming the pair of second surfaces of the case; and a wrapping step of disposing the electrode body on the first part of the plate material and bending the plate material so that a distance between the pair of second parts decreases, thereby wrapping the electrode body.

In the present disclosure, the plate material is bent so as to wrap the electrode body in the wrapping step; therefore, the accommodation property of the electrode body can be improved relatively compared to a conventional method in which an electrode body is inserted through an opening on one surface of a case main body. In the end, generation of a crease in a separator or displacement of an electrode plate when the electrode body is accommodated can be suppressed.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating an electrical energy storage device according to an embodiment;

FIG. 2 is a schematic longitudinal cross-sectional view taken along line II-II in FIG. 1;

FIG. 3 is a schematic longitudinal cross-sectional view taken along line III-III in FIG. 1;

FIG. 4 is a plan view of a plate material according to an embodiment;

FIG. 5A is a side view schematically illustrating an aspect at pressing in a second surface preliminarily forming step;

FIG. 5B is a side view schematically illustrating an aspect after the pressing in the second surface preliminarily forming step;

FIG. 6A is a side view schematically illustrating an aspect when electrode bodies are disposed in a wrapping step;

FIG. 6B is a side view schematically illustrating an aspect at pressing in the wrapping step;

FIG. 7 is a side view schematically illustrating an aspect in a bonding step;

FIG. 8 is a diagram corresponding to FIG. 3 when the number of electrode bodies is one according to a first modification;

FIG. 9 is a diagram corresponding to FIG. 3 when the number of electrode bodies is three according to a second modification; and

FIG. 10 is a diagram corresponding to FIG. 4 according to a third modification.

### DETAILED DESCRIPTION OF THE PREFERRED EMBODIMENTS

Hereinafter, preferred embodiments of the art disclosed herein will be described with reference to the drawings as appropriate. Matters that are other than matters particularly mentioned in the present specification and that are necessary for the implementation of the present disclosure (for example, the general configuration and manufacturing process of an electrical energy storage device that do not characterize the present disclosure) can be grasped as design matters of those skilled in the art based on the prior art in the relevant field. The art disclosed herein can be implemented on the basis of the disclosure of the present specification and common technical knowledge in the relevant field. Note that in the drawings below, the members and parts with the same operation are denoted by the same reference signs and the overlapping description may be omitted or simplified. Moreover, in the present specification, the notation “A to B” for a range signifies a value more than or equal to A and less than or equal to B, and is meant to encompass also the meaning of being “more than A” and “less than B”.

### Electrical Energy Storage Device

First, an electrical energy storage device manufactured by the art disclosed herein is described. Note that in the present specification, the term “electrical energy storage device” refers to general devices that are capable of being charged and discharged repeatedly, and corresponds to a concept encompassing secondary batteries such as lithium ion secondary batteries and nickel-hydrogen batteries and capacitors such as lithium ion capacitors and electrical double-layer capacitors.

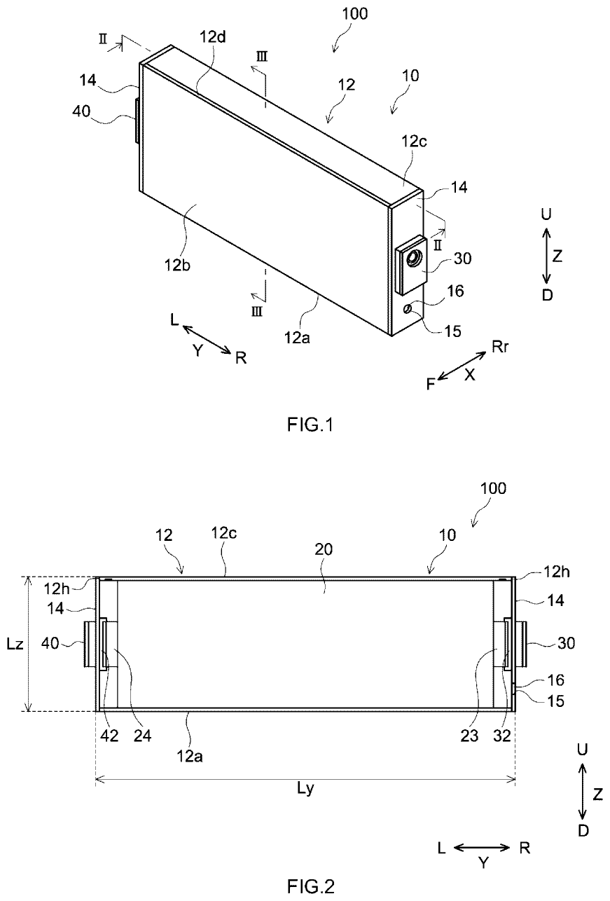

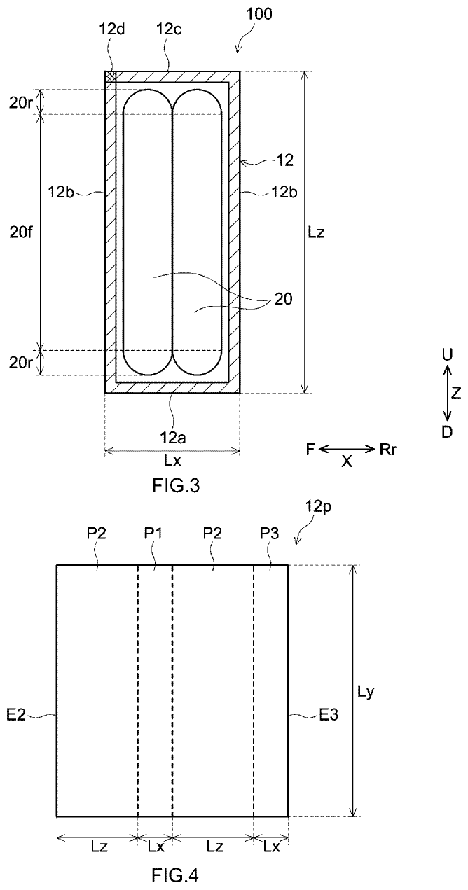

FIG. 1 is a perspective view schematically illustrating an electrical energy storage device 100 according to an embodiment. FIG. 2 is a schematic longitudinal cross-sectional view taken along line II-II in FIG. 1. FIG. 3 is a schematic longitudinal cross-sectional view taken along line III-III in FIG. 1. As illustrated in FIG. 1, the electrical energy storage device 100 has a square shape including a hexahedron (here, rectangular parallelepiped shape). In addition, in the description below, reference signs F, Rr, L, R, U, and D in the drawings respectively denote front, rear, left, right, up, and down, and reference signs X, Y, and Z in the drawings respectively denote a thickness direction of the electrical energy storage device 100, a width direction that is orthogonal to the thickness direction, and an up-down direction that is orthogonal to the thickness direction and the width direction. However, these are merely directions for convenience of description and do not limit the mode of installation of the electrical energy storage device 100.

As illustrated in FIG. 2, the electrical energy storage device 100 includes a case 10, one or a plurality of (two or more) electrode bodies 20, a positive electrode terminal 30, and a negative electrode terminal 40. The electrical energy storage device 100 further includes a nonaqueous electrolyte solution (not illustrated) here. The electrical energy storage device 100 is a nonaqueous electrolyte solution secondary battery here, and is a lithium ion secondary battery, for example.

The case 10 is a housing that accommodates the electrode body 20. Here, as illustrated in FIG. 1 and FIG. 2, the case 10 has an outer shape having a flat and bottomed square shape (rectangular parallelepiped shape here). The material of the case 10 may be the same as a material that has been used conventionally, and is not particularly limited. The case 10 is preferably made of metal and is more preferably formed of, for example, iron, an iron alloy such as stainless steel, aluminum, an aluminum alloy, or the like.

As illustrated in FIG. 2, here, the case 10 includes a case main body 12 with a square tubular shape having a pair of openings 12h at both end parts in the width direction Y, and two sealing plates 14 that close the pair of openings 12h of the case main body 12. The case 10 is integrated in such a way that the sealing plates 14 are bonded (for example, bonded by welding) to peripheries of the pair of openings 12h of the case main body 12. The case 10 is hermetically sealed (closed).

As illustrated in FIG. 1, the case main body 12 includes a bottom surface 12a with an approximately rectangular shape having long sides and short sides, a pair of long side surfaces 12b extending from the pair of long sides (a pair of edges) of the bottom surface 12a and facing each other, and a top surface 12c with an approximately rectangular shape facing the bottom surface 12a. The long side surface 12b is larger in area than the bottom surface 12a and the top surface 12c. The top surface 12c connects between upper end parts of the pair of long side surfaces 12b. In this embodiment, the bottom surface 12a is one example of “a first surface”, the pair of long side surfaces 12b are one example of “a pair of second surfaces”, and the top surface 12c is one example of “a third surface”. In another embodiment, however, the top surface 12c may be the first surface and the bottom surface 12a may be the third surface, for example.

Note that in the present specification, the term “substantially rectangular shape” encompasses, in addition to a perfect rectangular shape (rectangle), for example, a shape whose corner connecting a long side and a short side of the rectangular shape is rounded, a shape whose corner includes a notch, and the like.

The case main body 12 is formed in such a way that, here, one plate material 12p (see FIG. 4) is bent into a square tubular shape and the joint is bonded (for example, bonded by welding), which will be described in detail below. In this embodiment, as illustrated in FIG. 1 and FIG. 3, a bonding part (preferably, welding bonding part) 12d is provided at the top surface 12c of the case main body 12 and this bonding part 12d is formed by bonding the joint of the plate material 12p. The bonding part 12d is provided along a front corner part of the top surface 12c (border with the long side surface 12b on the front side).

The sealing plate 14 is a plate-shaped member that seals the opening 12h. The sealing plate 14 has a substantially rectangular shape in a plan view. As illustrated in FIG. 1 and FIG. 2, the sealing plate 14 is provided with a liquid injection hole 15. The liquid injection hole 15 is used to inject the electrolyte solution into the case 10 after the sealing plate 14 is assembled to the case main body 12. The liquid injection hole 15 is sealed with a sealing member 16 after the electrolyte solution is injected. Note that although the liquid injection hole 15 is provided in the sealing plate 14 in this embodiment, the liquid injection hole 15 may be provided in the case main body 12 in another embodiment.

The electrode body 20 is accommodated inside the case 10 as illustrated in FIG. 2 and FIG. 3. The structure of the electrode body 20 may be similar to the conventional one without particular limitations. The electrode body 20 may be accommodated inside the case 10 while being covered with an insulating sheet (electrode body holder) made of resin. As illustrated in FIG. 3, here, two (a plurality of) electrode bodies 20 are accommodated inside one case 10. The two electrode bodies 20 are disposed along the thickness direction (arrangement direction) X. However, the number of electrode bodies 20 to be accommodated inside one case 10 is not limited in particular and may be one, or three or more in another embodiment.

The electrode body 20 is here a wound electrode body in which a positive electrode with a band shape and a negative electrode with a band shape are stacked through a separator with a band shape and wound in a longitudinal direction using a winding axis as a center. However, in another embodiment, the electrode body 20 may be a multilayer electrode body in which a plurality of positive electrodes with a square shape (typically, a rectangular shape) and a plurality of negative electrodes with a square shape (typically, a rectangular shape) are stacked on each other in an insulated state.

As illustrated in FIG. 3, the electrode body 20 has an outer shape that is flat here. The electrode body 20 includes a pair of curved parts 20r and a pair of flat parts 20f coupling the pair of curved parts 20r. In this embodiment, the electrode body 20 is disposed inside the case 10 with the winding axis substantially parallel to the width direction Y. Therefore, the pair of curved parts 20r of the electrode body 20 face the bottom surface 12a and the top surface 12c of the case main body 12. The pair of flat parts 20f of the electrode body 20 face the pair of long side surfaces 12b of the case main body 12. However, in another embodiment, the electrode body 20 may be disposed inside the case 10 with the winding axis substantially parallel to the up-down direction Z, for example.

As illustrated in FIG. 2, a positive electrode tab 23 with a convex shape is provided in the positive electrode of the electrode body 20. The positive electrode tab 23 is electrically connected to the positive electrode terminal 30 through a positive electrode current collecting part 32. A negative electrode tab 24 with a convex shape is provided in the negative electrode of the electrode body 20. The negative electrode tab 24 is electrically connected to the negative electrode terminal 40 through a negative electrode current collecting part 42.

The nonaqueous electrolyte solution is accommodated inside the case 10 together with the electrode body 20. The nonaqueous electrolyte solution may be similar to the conventional one without particular limitations. The nonaqueous electrolyte solution typically contains a nonaqueous solvent and a supporting salt (electrolyte salt, for example Li salt or Na salt). The nonaqueous electrolyte solution is typically in a liquid form but may alternatively be in a gel form. In another embodiment, the electrical energy storage device 100 may contain a solid electrolyte instead of the nonaqueous electrolyte solution. In this case, the separator can be omitted.

The positive electrode terminal 30 and the negative electrode terminal 40 are fixed to the respective surfaces facing the case 10 (specifically, the pair of sealing plates 14) here. The positive electrode terminal 30 is attached to the sealing plate 14 disposed on one side in the width direction Y (on the right side in FIG. 1 and FIG. 2). The negative electrode terminal 40 is attached to the sealing plate 14 disposed on the other side in the width direction Y (on the left side in FIG. 1 and FIG. 2). In this embodiment, the positive electrode terminal 30 and the negative electrode terminal 40 are provided at the sealing plates 14; however, the positive electrode terminal 30 and the negative electrode terminal 40 may alternatively be provided at the case main body 12 in another embodiment.

The positive electrode terminal 30 is preferably made of metal, and is more preferably formed of aluminum or an aluminum alloy, for example. The negative electrode terminal 40 is preferably made of metal and is more preferably formed of copper or a copper alloy, for example. As illustrated in FIG. 2, the positive electrode terminal 30 is electrically connected to the positive electrode tab 23 of the electrode body 20 through the positive electrode current collecting part 32 inside the case 10. The negative electrode terminal 40 is electrically connected to the negative electrode tab 24 of the electrode body 20 through the negative electrode current collecting part 42 inside the case 10.

### Manufacturing Method for Electrical Energy Storage Device

The electrical energy storage device 100 can be manufactured suitably by a manufacturing method including, for example, a preparing step (step S1), a second surface preliminarily forming step (S2), a wrapping step (step S3), a plate material bonding step (step S4), and a sealing plate bonding step (step S5) typically in this order. However, the second surface preliminarily forming step (S2) is not essential and can be omitted in another embodiment. The manufacturing method according to this embodiment may include other step than those described above at an optional stage as appropriate. Each step will be described below.

The preparing step (step S1) is a step of preparing a plate material made of metal that constitutes at least a part of the case main body 12. FIG. 4 is a plan view of the plate material 12p according to one embodiment. The plate material 12p is preferably formed of, for example, iron, an iron alloy such as stainless steel, aluminum, an aluminum alloy, or the like. The plate material 12p has a flat plate shape here and has the thickness that is substantially uniform. The thickness of the plate material 12p is preferably about 0.1 to 2 mm, more preferably 0.2 to 1 mm, and still more preferably 0.4 to 0.8 mm from the viewpoints of mechanical strength, rigidity, durability, and the like, although there is no particular limitation. The thickness of the plate material 12p may be the same as the thickness of the sealing plate 14, for example, or may be larger than the thickness of the sealing plate 14.

As illustrated in FIG. 4, the plate material 12p has an approximately rectangular shape here. The plate material 12p includes at least a first part P1 that forms the bottom surface 12a (first surface) of the case 10, and a pair of second parts P2 that extend from the first part P1 and form the pair of long side surfaces 12b (the pair of second surfaces) of the case 10. The first part P1 has the same shape and size as those of the bottom surface 12a. The first part P1 has an approximately rectangular shape having long sides and short sides here. The second part P2 has the same shape and size as those of the long side surface 12b. The second parts P2 here extend from the pair of long sides of the first part P1. Note that in FIG. 4, reference signs Lx, Ly, and Lz denote the lengths respectively coinciding with the length (thickness) of the outer shape of the electrical energy storage device 100 in the thickness direction X, the length (width) thereof in the width direction Y, and the length (height) thereof in the up-down direction Z.

The plate material 12p preferably further includes one or two third parts P3 that extend from at least one of the pair of second parts P2 and form the top surface 12c (third surface) of the case 10. In FIG. 4, the plate material 12p further includes one third part P3 that extends from one second part P2 and forms the top surface 12c of the case 10. The third part P3 has the same shape and size as those of the top surface 12c here. The third part P3 extends from the long side of one second part P2 here. The first part P1, the second part P2, and the third part P3 have the long sides with the same length Ly.

In FIG. 4, border lines between the respective parts are expressed by dashed lines and these border lines virtually indicate the parts to be bent in the second surface preliminarily forming step (step S2) and/or the wrapping step (step S3) to be described below. In another embodiment, however, a notch, a guide, or the like may be provided at the border line, for example, so as to make it easy to bend the plate material 12p in the second surface preliminarily forming step (step S2) and/or the wrapping step (step S3).

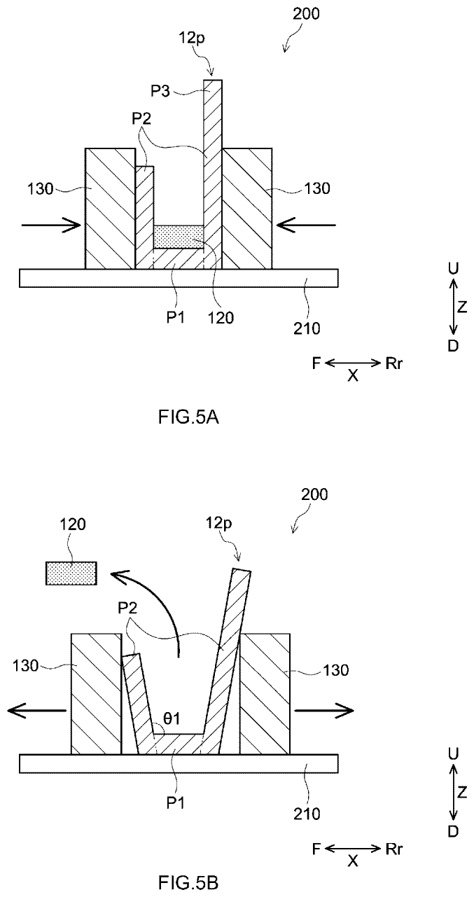

The second surface preliminarily forming step (step S2) is a step of bending the border between the first part P1 and the second part P2 of the plate material 12p at a bending angle larger than 90°. In this embodiment, the work from this step to the plate material bonding step (step S4) is performed using a manufacturing apparatus 200 (see FIG. 5A, etc.). In another embodiment, however, a part of or all the steps may be performed using another apparatus or performed manually. FIG. 5A is a side view schematically illustrating an aspect at pressing in this step. FIG. 5B is a side view schematically illustrating an aspect after the pressing in this step.

In this step, first, the plate material 12p prepared in the preparing step (step S1) is disposed on a formation stage 210 of the manufacturing apparatus 200 (see FIG. 5A, etc.). Next, as illustrated in FIG. 5A, after a pressing plate 120 is disposed at the first part P1 of the plate material 12p, the pair of second parts P2 are held between a pair of side surface pressurizing plates 130. The side surface pressurizing plates 130 are electrically connected to a control unit that is not illustrated here, and by the control unit, the side surface pressurizing plates 130 can be transferred between a pressed state in FIG. 5A (the pair of second parts P2 are pressed) and a retracted state in FIG. 5B (the pair of second parts P2 are not pressed). Next, as indicated by arrows in FIG. 5A, the pair of side surface pressurizing plates 130 are pressed to apply a predetermined amount of pressure on the plate material 12p; thus, the borders between the first part P1 and the second parts P2 are bent so that the pair of second parts P2 get close to each other. Accordingly, the bottom surface 12a (first surface) of the case 10 including the first part P1 is defined.

After the pressurization is completed, the pair of side surface pressurizing plates 130 are retracted and the pressing plate 120 is extracted as indicated by arrows in FIG. 5B. In this embodiment, the plate material 12p is bent so that an angle (bending angle) θ1 between the first part P1 and the second part P2 becomes larger than 90°. Thus, the interference between the electrode body 20 and the second part P2 of the plate material 12p in the subsequent wrapping step (step S3) can be prevented and the accommodation property of the electrode body 20 can be improved more.

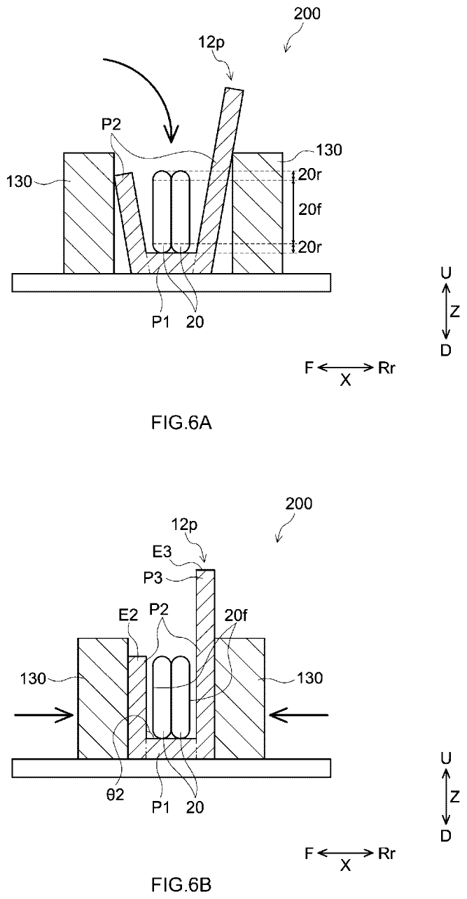

The wrapping step (step S3) is a step of wrapping the electrode body 20 by disposing one or the plurality of electrode bodies 20 on the first part P1 of the plate material 12p and bending the plate material 12p so that the distance between the pair of second parts P2 becomes narrow. FIG. 6A is a side view schematically illustrating an aspect when the electrode bodies are disposed in this step. FIG. 6B is a side view schematically illustrating an aspect at the pressing in this step.

In this step, the electrode body 20 is prepared first. In this embodiment, the sealing plate 14 is attached to the electrode body 20 before the plate material bonding step (step S4), which will be described below, so that an integrated object of the electrode body 20 and the sealing plate 14 is manufactured. Specifically, the positive electrode current collecting part 32 attached to the positive electrode tab 23 of the electrode body 20 is bonded to the positive electrode terminal 30 fixed to the sealing plate 14, and the negative electrode current collecting part 42 attached to the negative electrode tab 24 of the electrode body 20 is bonded to the negative electrode terminal 40 fixed to the sealing plate 14. The bonding can be performed by welding such as laser welding, ultrasonic welding, or resistance welding, for example. Note that the electrode body 20 may be covered with an insulating sheet. In another embodiment, the sealing plate 14 may be attached after the plate material bonding step (step S4), for example. In one example, the sealing plate 14 may be attached in the sealing plate bonding step (step S5).

Next, as indicated by an arrow in FIG. 6A, the electrode bodies 20 are disposed on the first part P1 of the plate material 12p. In this embodiment, the integrated object of the electrode bodies 20 and the sealing plate 14 (the illustration is omitted in FIG. 6A) is disposed on the first part P1 of the plate material 12p. The electrode bodies 20 (or the integrated object) are entirely accommodated below an upper end of the second part P2 of the plate material 12p. As described above, in this embodiment, the plurality of (specifically, two) electrode bodies 20 are used. Each of the plurality of electrode bodies 20 is a flat wound electrode body including the pair of curved parts 20r and the pair of flat parts 20f coupling the pair of curved parts 20r. The plurality of electrode bodies 20 are disposed on the first part P1 from above the second parts P2 of the plate material 12p here. Each of the plurality of electrode bodies 20 is disposed along the thickness direction (arrangement direction) X so that one curved part 20r (the lower one in FIG. 6A) faces the first part P1 of the plate material 12p.

Next, as indicated by arrows in FIG. 6B, the pair of side surface pressurizing plates 130 are pressed again to apply a predetermined amount of pressure on the plate material 12p so that the distance between the pair of second parts P2 is shortened; thus, the borders between the first part P1 and the second parts P2 are bent. Accordingly, an angle (bending angle) θ2 between the first part P1 and the second part P2 becomes approximately 90°, and the pair of flat parts 20f of the electrode body 20 become substantially parallel to the second parts P2 of the plate material 12p. In this manner, the pair of long side surfaces 12b (pair of second surfaces) of the case 10 formed of the pair of second parts P2 are defined. One curved part 20r (lower one in FIG. 6A) and the pair of flat parts 20f of the electrode body 20 are wrapped with the first part P1 and the pair of second parts P2 of the plate material 12p from three directions.

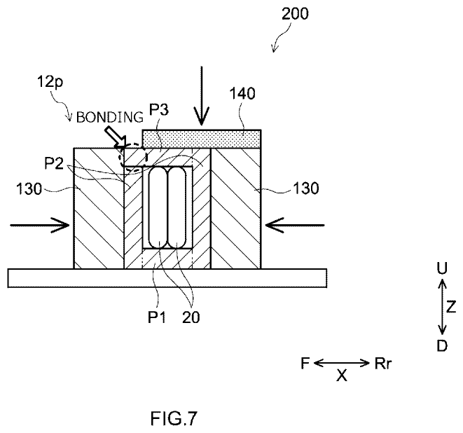

The plate material bonding step (step S4) is a step of bending the third part P3 of the plate material 12p so as to face the first part P1, thereby forming the plate material 12p into a square tubular shape and bonding the joint in a linear shape. In the plate material bonding step (step S4) in this embodiment, after the plate material 12p is formed into the square tubular shape, an end part E3 (see FIG. 4 and FIG. 6B) of the third part P3 of the plate material 12p and an end part E2 (see FIG. 4 and FIG. 6B) of the second part P2 that is in contact with the end part E3 are bonded to each other. FIG. 7 is a side view schematically illustrating an aspect in this step. In this embodiment, the pair of side surface pressurizing plates 130 keep pressing the pair of second parts P2 (pressed state) continuously from the wrapping step (step S3).

In this step, as illustrated in FIG. 7, the third part P3 of the plate material 12p is pressed with a top surface pressurizing plate 140 first and a predetermined amount of pressure is applied to the top surface pressurizing plate 140 as indicated by an arrow in FIG. 7, so that a border between the second part P2 and the third part P3 is bent. Thus, the angle (bending angle) between the second part P2 and the third part P3 becomes approximately 90° and the third part P3 becomes substantially parallel to the first part P1. In this manner, the top surface 12c (third surface) of the case 10 that is formed of the third part P3 is defined.

Next, as indicated by a circular mark in FIG. 7, the joint of the plate material 12p (specifically, the end part E3 of the third part P3 and the end part E2 of the second part P2 illustrated in FIG. 4 and FIG. 6B) is bonded in a linear shape. Note that the bonding method for the plate material 12p is not limited in particular and may be similar to the conventional method. The bonding can be performed by welding such as laser welding, ultrasonic welding, or resistance welding, for example. In addition, the bonding conditions may be similar to the conventional ones without particular limitations.

In some embodiments, the bonding is preferably performed with the pair of second parts P2 of the plate material 12p pressed from both sides. In this embodiment, the bonding is performed in a state where the pair of second parts P2 of the plate material 12p are sandwiched between the pair of side surface pressurizing plates 130 and pressed thereby from both sides. Thus, it is possible to suppress that the bending angle between the first part P1 and the second part P2 becomes more than 90°, and at the time of bonding, the substantially parallel state between the pair of second parts P2 can be kept easily. Accordingly, the formability and the size accuracy can be improved.

In this embodiment, the bonding is performed further with the third part P3 of the plate material 12p pressed by the top surface pressurizing plate 140. Thus, it is possible to suppress that the bending angle between the second part P2 and the third part P3 becomes more than 90°, and at the time of bonding, the substantially parallel state between the third part P3 and the first part P1 can be kept easily. Accordingly, the formability and the size accuracy can be improved.

When the electrode body 20 is a wound electrode body with a flat shape, the bonding is preferably performed at a position that is a corner part of the case 10 or at a position that is L/N from the corner part (in which N represents the number of electrode bodies 20 disposed in the case 10 and is an integer of 2 or more, and L represents the length of the case 10 in the thickness direction (arrangement direction) X of the electrode body 20). When the number of electrode bodies 20 disposed in one case 10 is 2 (N=2) as described in this embodiment, for example, the bonding is preferably performed at the position that is the corner part of the case 10, or at a position that is L/2 from the corner part in the thickness direction X (that is, at a center in the thickness direction X). Thus, the heat at the bonding conducts less easily to an upper end part of the electrode body 20, specifically to the curved part 20r on the side closer to the third part P3 (upper side in FIG. 7) and the thermal damage on the electrode body 20 can be suppressed.

In this embodiment, as illustrated in FIG. 7, the welding is performed at the corner part of the case 10, specifically along the front corner part of the top surface 12c (the border between the second part P2 and the third part P3). Thus, the linear bonding part 12d is provided as illustrated in FIG. 1 and FIG. 3. In this manner, the case main body 12 with the square tubular shape including the plate material 12p can be obtained.

In the sealing plate bonding step (step S5), two sealing plates 14 are prepared and bonded (for example, bonded by welding) to the periphery of the pair of openings 12h of the case main body 12 (see FIG. 2). The sealing plate 14 may be similar to the conventional one without particular limitations. The sealing plate 14 is preferably made of metal, and is preferably made of the same kind of metal as the plate material 12p, for example. The bonding method for the sealing plate 14 is not limited in particular and may be similar to the conventional method. The bonding of the sealing plate 14 can be performed by welding such as laser welding, ultrasonic welding, or resistance welding, for example. After the opening 12h is sealed with the sealing plate 14, the nonaqueous electrolyte solution is injected typically through the liquid injection hole 15 provided in the sealing plate 14 or the like. Then, the case 10 is sealed by closing the liquid injection hole 15 with the sealing member 16. In this manner, the electrical energy storage device 100 can be manufactured.

### Application of Electrical Energy Storage Device

The electrical energy storage device 100 can be used in various applications, and for example, suitably used as a motive power source (electrical power source for driving) for a motor mounted on a vehicle such as a passenger car or a truck. Although the type of vehicles is not particularly limited, examples thereof may include a plug-in hybrid electric vehicle (PHEV), a hybrid electric vehicle (HEV), a battery electric vehicle (BEV), and the like.

Although the preferable embodiments of the present disclosure have been described above, they are merely examples. The present disclosure can be implemented in various other modes. The present disclosure can be implemented based on the contents disclosed in the present specification and the technical common sense in the relevant field. The techniques described in the scope of claims include those in which the embodiments exemplified above are variously modified and changed. For example, another modification can replace a part of the aforementioned embodiment or be added to the aforementioned embodiment. Additionally, the technical feature may be deleted as appropriate unless such a feature is described as an essential element.

For example, the aforementioned manufacturing method may further include a third surface preliminarily forming step of bending the border between the second part P2 and the third part P3 of the plate material 12p after the preparing step (step S1) and before the wrapping step (step S3). In this case, it is preferable to exclude the second surface preliminarily forming step (step S2) from the viewpoint of preventing the interference between the bent third part P3 and the electrode body 20 in the wrapping step (step S3).

For example, the aforementioned manufacturing method includes the second surface preliminarily forming step (step S2) before the wrapping step (step S3), and in the second surface preliminarily forming step (step S2), the border between the first part P1 and the second part P2 is bent to make a crease in advance. However, the present disclosure is not limited to this example. In a case where the border between the first part P1 and the second part P2 has a notch, a guide, or the like provided in advance, for example, the second surface preliminarily forming step (step S2) may be omitted and the plate material with the flat plate shape may be subjected to the wrapping step (step S3) directly.

For example, in the embodiment described above, the electrode body 20 is a wound electrode body with the flat shape, and in the plate material bonding step (step S4), the bonding is performed at the position that is the corner part of the case 10 or at the position that is L/N from the corner part. However, the present disclosure is not limited to this example. In a modification, the electrode body 20 may be a multilayer electrode body. In this case, the bonding is preferably performed at the position that is the corner part of the case 10 in the plate material bonding step (step S4). Thus, the heat at the bonding conducts less easily to the upper end part of the electrode body 20, and the thermal damage on the electrode body 20 can be suppressed.

For example, in the embodiment described above, the two electrode bodies 20 are used as illustrated in FIG. 3, etc. However, the present disclosure is not limited to this example. The number of electrode bodies 20 to be accommodated in one case 10 may be one, or three or more.

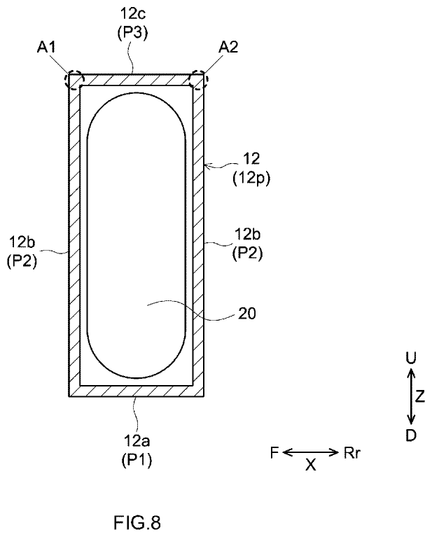

FIG. 8 is a diagram corresponding to FIG. 3 according to a first modification in which the number of electrode bodies 20 is one. Note that the portions corresponding to those in the plate material 12p are denoted in parenthesis here. In a case where the number of electrode bodies 20 to be disposed in one case 10 is one, the bonding in the plate material bonding step (step S4) is preferably performed at the position that is the corner part of the case 10, here, at the position that is a front corner part A1 or a rear corner part A2 of the top surface 12c of the case 10 as indicated by circles in FIG. 8. Although the bonding is performed at the position that is the top surface 12c here, the bonding may alternatively be performed at the position that is the bottom surface 12a, for example.

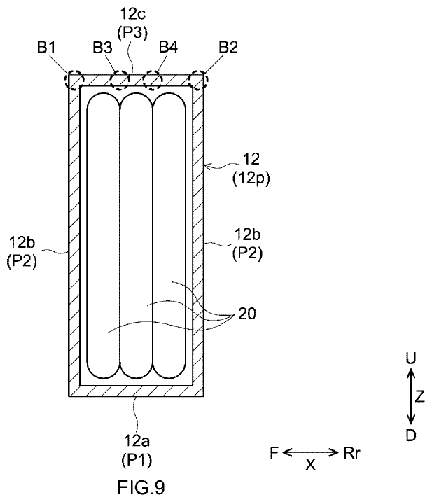

FIG. 9 is a diagram corresponding to FIG. 3 according to a second modification in which the number of electrode bodies 20 is three. In a case where the number of electrode bodies 20 to be disposed in one case 10 is three (N=3), the bonding in the plate material bonding step (step S4) is preferably performed at the position that is the corner part of the case 10 or at a position that is L/3 from the corner part in the thickness direction X. Here, it is preferable to perform the bonding at any one of positions among a position that is a front corner part B1, a position that is a rear corner part B2, and positions B3 and B4 that are L/3 from the corner parts B1 and B2 in the thickness direction X on the top surface 12c of the case 10 as indicated by circles in FIG. 9. Although the bonding is performed at the position that is the top surface 12c here, the bonding may alternatively be performed at the position that is the bottom surface 12a, for example.

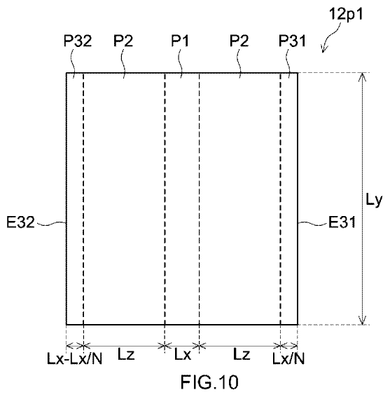

In the plate material 12p in FIG. 4 described above, for example, one third part P3 is used and has the same shape and size as those of the top surface 12c. However, the present disclosure is not limited to this example. FIG. 10 is a diagram corresponding to FIG. 4 according to a third modification. As illustrated in FIG. 10, a plate material 12p1 includes two third parts P31 and P32. The two third parts P3 extend from the long sides of the pair of second parts P2 here. Bonding the two third parts P31 and P32 along the joint makes the same shape and size as those of the top surface 12c.

For example, when the number of electrode bodies 20 to be disposed in one case 10 is two (N=2), the length of each of the two third parts P31 and P32 in the short side direction is Lx/2. In this modification, in the plate material bonding step (step S4), an end part E31 of the third part P31 and an end part E32 of the third part P32 in the plate material 12p1 are bonded together. Thus, the bonding part is provided in a linear shape at a center of the top surface 12c of the case main body 12 in the thickness direction X, for example.

As described above, the following items are given as specific aspects of the art disclosed herein.

Item 1: The manufacturing method for an electrical energy storage device including one or the plurality of electrode bodies and the case that has the square shape and accommodates the electrode body or the electrode bodies, in which the case includes at least the first surface, the pair of second surfaces extending from the pair of edges of the first surface and facing each other, and the third surface facing the first surface, the manufacturing method including: the preparing step of preparing the plate material that is made of metal and includes at least the first part forming the first surface of the case, and the pair of second parts extending from the first part and forming the pair of second surfaces of the case; and the wrapping step of disposing the electrode body on the first part of the plate material and bending the plate material so that the distance between the pair of second parts decreases, thereby wrapping the electrode body.

Item 2: The manufacturing method for an electrical energy storage device according to Item 1, in which the plate material prepared in the preparing step further includes one or two third parts that extend from at least one of the pair of second parts and form the third surface of the case.

Item 3: The manufacturing method for an electrical energy storage device according to Item 2, further including, after the wrapping step, the plate material bonding step of bending the third part of the plate material so as to face the first part and to form the plate material into the square tubular shape, and bonding the joint in the linear shape.

Item 4: The manufacturing method for an electrical energy storage device according to Item 3, in which in the plate material bonding step, the bonding is performed with the pair of second parts of the plate material pressed from both sides.

Item 5: The manufacturing method for an electrical energy storage device according to Item 3 or 4, in which the plurality of electrode bodies are used, and each of the plurality of electrode bodies is the wound electrode body with the flat shape including the pair of curved parts and the pair of flat parts coupling the pair of curved parts, in the wrapping step, each of the plurality of wound electrode bodies is disposed along the arrangement direction so that one of the curved parts faces the first part, and in the plate material bonding step, the bonding is performed at the position that is the corner part of the case or at the position that is L/N from the corner part (in which N represents the number of electrode bodies disposed in the case and is an integer of 2 or more, and L represents the length of the case in the arrangement direction of the electrode bodies).

Item 6: The manufacturing method for an electrical energy storage device according to Item 3 or 4, in which the electrode body is the multilayer electrode body, and in the plate material bonding step, the bonding is performed at the position that is the corner part of the case.

Item 7: The manufacturing method for an electrical energy storage device according to any one of Items 1 to 6, further including, after the preparing step and before the wrapping step, the second surface preliminarily forming step of bending the border between the first part and the second part of the plate material with a bending angle of more than 90°.

Item 8: The manufacturing method for an electrical energy storage device according to any one of Items 1 to 6, further including, after the preparing step and before the wrapping step, the third surface preliminarily forming step of bending the border between the second part and the third part of the plate material.

### REFERENCE SIGNS LIST

10 Case
12 Case main body
12a Bottom surface (first surface)
12b Long side surface (second surface)
12c Top surface (third surface)
12d Bonding part
14 Sealing plate
20 Electrode body
20f Flat part
20r Curved part
100 Electrical energy storage device
12p, 12p1 Plate material
P1 First part
P2 Second part
P3, P31, P32 Third part

What is claimed is:

1. A manufacturing method for an electrical energy storage device including one or a plurality of electrode bodies and a case that has a square shape and accommodates the electrode body or the electrode bodies, in which the case includes at least a first surface, a pair of second surfaces extending from a pair of edges of the first surface and facing each other, and a third surface facing the first surface, the manufacturing method comprising:
a preparing step of preparing a plate material that is made of metal and includes at least a first part forming the first surface of the case, and a pair of second parts extending from the first part and forming the pair of second surfaces of the case; and
a wrapping step of disposing the electrode body on the first part of the plate material and bending the plate material so that a distance between the pair of second parts decreases, thereby wrapping the electrode body.

2. The manufacturing method for an electrical energy storage device according to claim 1, wherein the plate material prepared in the preparing step further includes one or two third parts that extend from at least one of the pair of second parts and form the third surface of the case.

3. The manufacturing method for an electrical energy storage device according to claim 2, further comprising, after the wrapping step, a plate material bonding step of bending the third part of the plate material so as to face the first part and to form the plate material into a square tubular shape, and bonding a joint in a linear shape.

4. The manufacturing method for an electrical energy storage device according to claim 3, wherein in the plate material bonding step, the bonding is performed with the pair of second parts of the plate material pressed from both sides.

5. The manufacturing method for an electrical energy storage device according to claim 3, wherein
the plurality of electrode bodies are used, and each of the plurality of electrode bodies is a wound electrode body with a flat shape including a pair of curved parts and a pair of flat parts coupling the pair of curved parts,
in the wrapping step, each of the plurality of wound electrode bodies is disposed along an arrangement direction so that one of the curved parts faces the first part, and
in the plate material bonding step, the bonding is performed at a position that is a corner part of the case or at a position that is L/N from the corner part (in which N represents the number of electrode bodies disposed in the case and is an integer of 2 or more, and L represents a length of the case in the arrangement direction of the electrode bodies).

6. The manufacturing method for an electrical energy storage device according to claim 3, wherein
the electrode body is a multilayer electrode body, and
in the plate material bonding step, the bonding is performed at a position that is a corner part of the case.

7. The manufacturing method for an electrical energy storage device according to claim 1, further comprising, after the preparing step and before the wrapping step, a second surface preliminarily forming step of bending a border between the first part and the second part of the plate material with a bending angle of more than 90°.

8. The manufacturing method for an electrical energy storage device according to claim 2, further comprising, after the preparing step and before the wrapping step, a third surface preliminarily forming step of bending a border between the second part and the third part of the plate material.
